(19) United States
(12) Patent Application Publication
(10) Pub. No.: US 2003/0031757 A1
(43) Pub. Date: Feb. 13, 2003

(54) Stable and bioavailable iron fortified beverages

(75) Inventors: Ahmad Akashe, Mundelein, IL (US); Cheryl Baldwin, Mundelein, IL (US); Barbara Lyle, Deerfield, IL (US); Manuel Marquez, Prospect Heights, IL (US)

Correspondence Address: FITCH EVEN TABIN AND FLANNERY, 120 SOUTH LA SALLE STREET, SUITE 1600, CHICAGO, IL, 60603-3406, US

(73) Assignee: KRAFT FOOD HOLDINGS, INC.

(21) Appl. No.: 09/921,953

(22) Filed: Aug. 3, 2001

(51) Int. Cl. A23L 2/00

(52) U.S. Cl. 426/66

(57) ABSTRACT

Beverages and powdered beverage mixes fortified with ferric EDTA as an iron source are provided. The beverages and beverage mixes fortified with ferric EDTA according to this invention have superior iron bioavailability and excellent storage stability. The present invention also is directed to a method of using such ferric EDTA-fortified beverages to prevent or treat iron-deficiency anemia in individuals by administering the iron fortified beverage of the invention in an effective amount to an individual in need thereof.

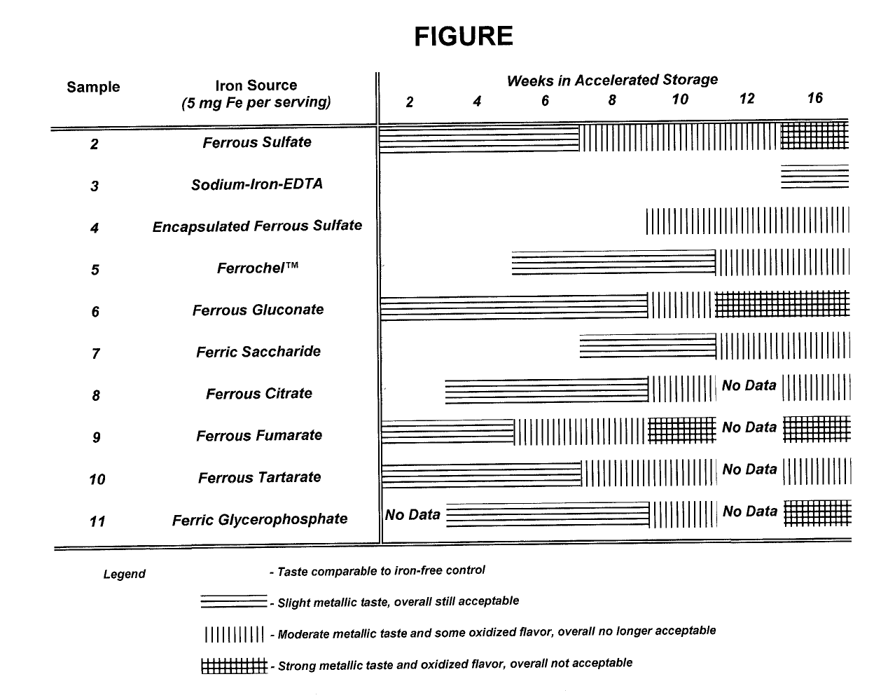

### FIELD OF THE INVENTION

The present invention generally relates to beverages, including powdered beverage mixes, fortified with stable and bioavailable iron. The present invention also is directed to a method to prevent or treat iron-deficiency anemia in individuals by administering an iron fortified beverage of the invention in an effective amount to an individual in need thereof.

### BACKGROUND OF THE INVENTION

The mineral iron is needed in the diet as it functions primarily as a carrier of oxygen in the body, both as part of hemoglobin in the blood and myoglobin in the muscles. Iron deficient diets can lead or contribute to anemia, a condition in which the size and number of red blood cells are reduced. In general, a good food source of iron contains a substantial amount of iron in relation to its serving size. For instance, in the United States good source of iron should provide at least about 10% of the U.S. Daily Value (U.S. DV) for iron in a selected serving size. The current U.S. DV for iron is 18 milligrams per day for adults.

Iron deficiencies in human populations remains a global problem and is one of the most prevalent nutritional deficiencies worldwide. Approximately one fifth of the world's population suffer from some nutritional iron deficiency. Hurrell, Nutrition Reviews, 55(6):210-222 (1997). Women and children comprise the majority of iron deficiency cases; in developing countries, sometimes as many as 50 percent of children are effected. Iron deficiency increases the risk of premature labor, low birth weight babies and prenatal mortality in pregnant women. Yip et al., “Iron in Present Knowledge in Nutrition,” 7 ed., International Life Sciences Institute, Washington, D.C. 1996, pp. 277-292. It also effects child development, physical performance, and mental development. Even in the developed countries, a high percentage of adult women have iron intakes below their U.S. DV.

The main source of iron in the diet of many people comes from heme iron present in meat and meat products (e.g., animal, poultry, or fish). Heme iron is readily absorbed by the body. However, meat and meat products often are not available or affordable to people living in underdeveloped areas. Also, many consumers are on meat-restricted or meat-free diets by choice. Therefore, meat products are often consumed at inadequate levels by many individuals to solely meet their nutritional needs for mineral iron. As to alternate sources of iron, non-heme iron can be derived from plant sources, but it has low bioavailability due to poor absorption and/or presence of iron absorption inhibitors in those food sources. Absorption of non-heme iron from a diet in humans can be enhanced by the presence of L-ascorbic acid (i.e., vitamin C). However, vitamin C supplementation increases the cost of a food when added in amounts effective for that result, and it also may represent an unstable ingredient.

Generally beverages have high water activity and moisture content which facilitate the movement and reactivity of compounds, especially water soluble forms, in the product. Iron is a highly reactive compound. As a result, iron fortified products having high moisture and/or water activity levels have typically used low reactivity forms, including water insoluble and/or inert iron compounds as the iron source. These low reactivity iron forms generally limit the development of off-flavors and colors commonly associated with iron fortification. Unfortunately, they also have limited bioavailability and are not readily utilizable by the body; further, due to limited solubility, sediments are likely to form when used in beverage products. Prior attempts of fortifying foods and beverages directly with soluble iron forms, such as by addition of ferrous sulfate, has proven very problematic, often causing unpleasant color and taste effects, especially metallic off-tastes, which can render food and beverage products unpalatable.

Iron complexes have been added to solid foods in efforts to fortify those food products with iron. In U.S. Pat Nos. 5,667,825 and 5,534,275, cereal products are fortified with sodium ferric ethylenediaminetetraacetic acid complex as the iron source. Such cereal products have low water activity and, accordingly, the reactivity and bioavailability of the iron is generally limited.

EDTA has been used in various foods, beverages, and other edible products. U.S. Pat. No. 4,299,853 describes preservatives for alcoholic beverages subject to biological instability on storage involving certain EDTA additives, which include water soluble alkali or alkaline earth metal salts of EDTA, such as sodium, potassium, and calcium salts of EDTA. U.S. Pat. No. 3,956,513 describes a solid product for use in the flavoring of food or beverages which comprises a water-insoluble calcium, magnesium, nickel, manganese, or zinc isohumolone complex and an alkali metal compound or a mixture of alkali metal salts of EDTA (e.g., disodium, dipotassium, tetrasodium, or tetrapotassium salts of EDTA) in a molar ratio of the alkali metal compound to the isohumolone complex of at least 0.8 to 1. In U.S. Pat. No. 4,820,520, NaEDTA has been described for use in combination with antiseptic agents to enhance antifungal activity in food and drinks. U.S. Pat. No. 4,937,085 describes a food preservation composition to prevent discoloration of potatoes comprising citric acid, cysteine, ascorbic acid, and trace amounts of EDTA. U.S. Pat. Nos. 4,020,158, 4,830,716, and 5,516,925 provide metal (including iron) amino acid chelates for administering to humans and other animals as a dietary supplement; an liquid iron supplement is commercially available from Albion Laboratories, Inc. (Clearfield, Utah) under the tradename Ferrochel™. U.S. Pat. No. 5,653,987 describes a liquid pharmaceutical agent formulation suitable for oral or nasal delivery comprising a proteinic pharmaceutical agent, water and at least two absorption enhancing compounds which can include disodium EDTA.

As can be appreciated, there remains a need for approaches for fortifying beverages with iron to provide enhanced iron bioavailability and stability. The present invention fulfills this, as well as other needs and objectives, as will be apparent from the following description of embodiments of the present invention.

### SUMMARY OF THE INVENTION

This invention provides for beverages fortified with ferric EDTA as an iron source. The beverages fortified with ferric EDTA according to this invention have superior iron bioavailability. Moreover, the ferric EDTA fortified beverage drinks of this invention have excellent storage stability. They also are highly palatable and are essentially free of unacceptable off-tastes or off-flavors, even at relatively high iron levels.

In the present invention, it surprisingly has been found that the iron in the ferric EDTA does not appreciably interchange with other cations often present in a beverage formulation with added vitamin/mineral mixes (e.g., sodium, calcium, potassium, zinc, iodine, vitamin C, vitamin E, and the like). As a consequence, no significant free iron is generated in solution to be available to react and form off-flavors or colors, as is often the case for other soluble iron forms. It is believed that ferric EDTA chelates the iron sufficiently to render it unavailable for reactivity, even in relatively dilute aqueous forms used in non-limiting embodiments of the inventive beverage. This advantage of the inventive beverages is applicable to either ready-to-drink (RTD) liquid forms or forms thereof reconstituted from dry powdered mixes containing effective amounts of ferric EDTA. For purposes herein, the terminology “ferric EDTA” means “sodium ferric ethylenediaminetetraacetic acid” or “sodium iron ethylenediaminotetracetic acid” (i.e., NaFeEDTA).

In one aspect of the present invention, a beverage composition is provided as either a fluid product or dry mix product which can be reconstituted and that generally contains at least about 1 percent of the U.S. DV for iron per fluid ounce of the beverage. Preferably, the beverages of this invention provide about 1 to about 30 percent, and more preferably about 1 to about 5 percent, of the U.S. DV for iron per fluid ounce of the beverage. A typical 6 to 8 ounce liquid serving of the inventive beverage containing iron at these levels can provide a significant portion of an individual's U.S. DV iron requirement. For example, in one preferred embodiment, the beverage composition generally contains about 18 to about 33 percent of the U.S. DV for iron, as introduced via ferric EDTA, per six ounce serving of a beverage according to the invention. To achieve these proportions, the ferric EDTA is preferably incorporated into the formulations of this invention at a level greater than about 0.2 mg Fe or more, preferably at about 0.2 to about 3.0 mg Fe, and more preferably at about 0.4 to about 1.2 mg Fe, per fluid ounce of the final beverage.

In this invention, iron is introduced into the beverage or beverage powder via ferric EDTA. The ferric EDTA preferably is used as the sole source of iron in the beverage or beverage powder mix. The ferric EDTA does not have to be used in combination with other iron sources to provide sufficient amounts of bioavailable iron. Indeed, the presence of other supplemental iron sources, such as ferrous sulfate, ferrous fumurate, ferrous citrate, and so forth, can detract from or compromise the advantageous stability and palatability attributes otherwise achieved by iron fortifying the beverage via ferric EDTA alone and are, therefore, preferably avoided.

The present invention also is directed to a method to prevent or treat iron-deficiency anemia in individuals by administering the fortified beverage of the invention in an effective amount to the individuals in need thereof.

### BRIEF DESCRIPTION OF THE DRAWING

Other features and advantages of the present invention will become apparent from the following detail description of preferred embodiments of the invention with reference to the drawing(s), in which:

The FIGURE is a bar graph showing taste evaluation results for a series of reconstituted beverages containing different sources of iron.

### DETAILED DESCRIPTION OF THE INVENTION

The present invention generally relates to beverages that are iron-fortified using ferric EDTA. Such iron-fortified beverage include ready-to-drink (RTD) beverages and powdered beverage mixes which can be reconstituted using appropriate liquids. The form of iron used in the present invention (i.e., ferric EDTA or sodium iron EDTA) is water soluble and thus ostensibly would be expected to have high reactivity in high moisture and aqueous food/beverage products and be prone to developing off-flavors and off-colors. In other words, with the extremely high water content and activity in beverages, one would normally expect the iron ions in the ferric EDTA to be interchangeable with other cations commonly present in beverages (e.g., sodium or calcium), thereby allowing free iron ions to be available to react and form off-flavors or off-colors (as is often the case for soluble iron forms). Surprisingly, this has not been found to occur in using ferric EDTA to fortify beverages according to this invention.

As illustrated in the examples described below, it has been demonstrated that ferric EDTA does not develop undesirable metallic off-flavors or off-colors in either reconstituted powdered beverages or in ready-to-drink beverages. Moreover, acceptable taste results were achieved in beverages fortified with ferric EDTA according to this invention, at levels exceeding comparative beverages that were fortified with other iron forms. Namely, iron- related organoleptic defects in terms of metallic off-tastes, flavor oxidation, and/or stale-taste attributes normally associated with iron fortificants have not been detected by evaluators sampling beverages fortified with ferric EDTA according to this invention.

In the practice of the present invention, preferably the solutes, including the ferric EDTA, are added to the liquid medium of the beverage at levels at or below saturation levels, so that significant sediments or solid residues are not formed or deposited within the holding container. In one aspect, the iron-fortified beverages according to the invention contain ferric EDTA generally in an amount to provide at least about 1 percent, preferably about 1 to about 30 percent, and more preferably about 1 to about 5 percent, of the U.S. DV for iron per fluid ounce of the beverage. To achieve such iron levels, ferric EDTA generally is added into the inventive beverage solutions at a rate of about 0.2 mg or more Fe, preferably from about 0.2 to about 3.0 mg Fe, more preferably from about 0.4 to about 1.2 mg Fe, per fluid ounce of the RTD or reconstituted beverages of this invention. Ferric EDTA or NaFeEDTA generally contains about 12 percent Fe. Thus, the amount of ferric EDTA to be added to achieve the above-indicated iron addition levels can be readily calculated and implemented.

For either RTD or reconstituted beverages according to the invention, the primary common ingredients are ferric EDTA (in amounts effective to help meet the U.S. DV requirements) and a potable liquid in which the ferric EDTA is soluble. Optional edible ingredients, such as, for example, flavorings, sweeteners, vitamins, minerals, and the like can be included in the beverages and powdered beverage mixes of this invention so long as they do not result in off-tastes, off-colors, or other organoleptic properties which are unacceptable. Preferably for the RTD or reconstituted beverages RTD or reconstituted beverages according to the invention, the primary common ingredients are ferric EDTA (in amounts effective to help meet the U.S. DV requirements), a flavoring material, and a potable liquid in which the ferric EDTA and the flavoring material are soluble. Preferably the only form of added iron is ferric EDTA.

The potable liquid in which the ferric EDTA, flavoring material, and any other ingredients is dissolved can be aqueous-based, alcohol-based, or any other suitable and potable liquid solvent for the ingredients. Water-based liquid vehicles are generally preferred in the practice of the invention. The proportion of liquid generally will be that sufficient to permit solubilization of the ingredients and also sufficient to permit the desired strength/dilution of the flavoring agents to be achieved. Generally, the proportion of water used in fruit drink beverages encompassed by the invention, whether RTD or reconstituted forms, will be about 50 to about 99 percent.

When a fortified beverage according to this invention is a fruit-flavored beverage, water-soluble and water-dispersible flavoring agents, both natural and synthetic, can be used, including, for example, commercially available fruit drink flavoring agents for. Common fruit flavoring materials useful in this invention include, for example, orange oil, lime oil, lemon oil, and the like. Other flavoring materials also can be found in published formulation recipes for fruit drinks. Also, natural fruit juice concentrates can be added to the beverages to provide or accentuate the fruit flavoring desired. These concentrates typically will be in liquid, pulped, or syrup forms. A fruit juice concentrate generally contains at least about 45 percent fruit juice.

In one embodiment, the flavoring agent in the beverage is an orange flavor. Commercially obtainable orange flavor concentrates are available that contain terpenes. These terpenes tend to be highly susceptible to oxidation and, thus, tend to develop off-flavors. Insufficiently stabilized iron will oxidize these orange flavor components. Ferric EDTA successfully stabilizes the iron such that it was not available to react with the orange flavor in a beverage.

Food colorings, such as, for example, U.S. Certified Food Colors, also can be added to the inventive beverages. Preservatives also can be added to the inventive beverages; examples include sodium benzoate, ascorbic acid, citric acid, lactic acid, malic acid, tartaric acid, propylene glycol, and the like. Also, in the case of the dry powdered beverage mixes of the invention, users often can be expected to use tap water to reconstitute the beverage. Since tap water often is slightly alkaline due to the presence of dissolved mineral salts therein, acidulants, such as citric acid, phosphoric acid, or malic acid, and so forth, also can be included to neutralize the alkalinity of tap water, or for other purposes. Preferably the preservative is an edible acid such as, for example, ascorbic acid, citric acid, lactic acid, malic acid, tartaric acid, and mixtures thereof; such edible acids can, of course, neutralize any alkalinity present in the reconstituting liquid used. For RTD beverages of the invention, it also optionally is possible to carbonate the beverage prior to its packaging. The powdered beverage mixes of this invention optionally can be reconstituted in a carbonated liquid, or they optionally can be carbonated after reconstitution.

The beverages of this invention also can contain a sweetener. The sweetener can be selected, for example, from one or more of sucrose, glucose, fructose, hydrolyzed corn starch, maltodextrin, corn syrup solids, lactose, high fructose corn syrup, fructooligosaccharides, artificial sweeteners, and mixtures thereof. Suitable artificial sweeteners include, for example, aspartame, sucralose, saccharine, cyclamates, acesulfame potassium, and the like. In the case of powdered dry mixes according to the invention, the sweetener generally will be present in granulated form in the mix prior to reconstituting the drink. The amount of sweetener can vary, but generally, if present, is the range of from 0 to about 50 percent, and more preferably about 5 to about 25 percent, of the RTD or reconstituted beverage.

In that embodiments of the invention encompass nonfat beverage products, the desirable mouthfeel that would normally be provided by fat content can instead be provided by non-fat stabilizers, such as, but not limited to, celluloses such as carboxymethyl cellulose, sodium carboxymethyl cellulose, hydroxymethyl cellulose, hydroxypropyl methyl cellulose, cellulose gel, and zanthan gum, carrageenans, guar gum, gum arabic, and the like, as well as mixtures thereof. In the beverages of the invention, the amount of such stabilizers generally can be from 0 to about 30 and more preferably about 5 to about 15 percent.

Fat also optionally can be introduced as an ingredient of the beverages, such as in the form of butterfat, soy oil, hydrogenated soy oil, fractionated coconut oil, high oleic safflower oil, corn oil, canola oil, cocoa butter, and the like, as well as mixtures thereof. Proteins also optionally can be introduced as an ingredient of the beverages, such as in the form of dairy protein, vegetable protein (e.g., soy, wheat), and the like as well as mixtures thereof. For example, soy drinks can be prepared as RTD beverages or as beverages reconstituted from powdered dry mixes according to embodiments of the invention.

The powdered beverage mixes of the present invention can be formed from a dried flavor base containing the ferric EDTA. Such flavor bases can be dried by conventional means known to the art, such as spray drying, evaporative drying, vacuum drying, freeze drying, and the like, or can be prepared by drying blending the various ingredients. Preferably, the drying method provides rapidly dissolvable particles having an average diameter of about 10 to about 1000 microns. Sugar and/or stabilizers also can be used as carriers for other ingredients of the dried flavor base.

Powdered beverage mixes include fruit flavored powdered drinks, dairy beverages, vegetable based beverages (e.g., soy milk), and the like. RTD beverages include fruit flavored powdered drinks, dairy beverages, vegetable based beverages (e.g., soy milk), and the like. The beverages fortified according to this invention also can be frozen to form pop sickles, sorbet, and the like, or other convenient forms for storage and consumption (e.g., beverage concentrates, confections, and the like).

A preferred soluble, dry powdered beverage mixture according to one illustrative, non-limiting, embodiment of the invention, comprises, on a dry basis, about 0.01 to about 0.2 percent ferric EDTA, about 40 to about 70 percent citric acid, about 5 to about 25 percent flavoring agent, about 5 to about 30 percent stabilizer, about 0 to 15 percent colorant, and about 5 to about 15 percent of a vitamin/mineral blend. The terms “dry” or “powdered” used herein generally mean relatively free-flowable materials having less than about 3 percent water content.

The ingredients of the inventive beverage compositions can be mixed using conventional techniques. For example, the dry components can be mixed with the liquid vehicle with stirring and agitation to the extent needed to dissolve the ingredients and ensure a substantially uniform dispersion of the ingredients.

As discussed above, the iron-fortified beverages of this invention include powdered beverage mixes and ready-to-drink (RTD) beverages. Whether prepared as RTD or reconstituted beverages, the ferric EDTA used in fortifying in beverages according to this invention is highly bioavailable. Indeed, it is comparable to ferrous sulfate, normally considered the universal standard for iron bioavailability. Indeed, in the presence of dietary inhibitors such as phytate or phytic acid, the iron associated with ferric EDTA is even more available than the iron in ferrous sulfate. Moreover, ferric EDTA does not result in the unpleasant organoleptic attributes normally of the U.S. DV for iron per fluid ounce of the beverage associated with ferrous sulfate.

The Examples that follow are intended to illustrate, and not to limit, the invention. All percentages used herein are by weight, unless otherwise indicated.

### EXAMPLE 1

Basic powdered beverage formulations, as detailed in Table 1, were prepared using different forms of iron. The stability of the various products were evaluated over their shelf life by a trained panel for sensorial attributes.

TABLE 1
Basic Powdered Beverage Formulation.

| Ingredient | Amount (%) |
|---|---|
| iron fortification agent¹ | 0.2 |
| citric acid | 58.5 |
| orange flavoring² | 14.9 |
| orange coloring | 5.1 |
| carboxymethyl cellulose | 10.1 |
| vitamins & mineral blend³ | 10.2 |
| titanium oxide | 1.0 |

¹Amount based on iron (Fe) content only; provides about 5 mg Fe per 22 g serving (dry mix).
²Commercially available orange concentrate containing terpenes
³Vitamin C, vitamin E, zinc, iodine, and calcium

The various iron fortification agents used are shown in Table 2.

TABLE 2
Iron Fortification Agents.

| Sample | Iron Fortification Agent |
|---|---|
| 1 | none (negative control) |
| 2 | ferrous sulfate (positive control) |
| 3 | sodium iron EDTA (inventive) |
| 4 | encapsulated ferrous sulfate |
| 5 | Ferrochel ™ |
| 6 | ferrous gluconate |
| 7 | ferric saccharide |
| 8 | ferrous citrate |
| 9 | ferrous fumarate |
| 10 | ferrous tartarate |
| 11 | ferric glycerophosphate |

The encapsulated ferrous sulfate was obtained from Balchem Corp. (Slate Hill, N.Y.). Ferrochel™ is a nutritionally functional mineral amino acid chelate containing iron for use in food fortification from Albion Laboratories, Inc. (Clearfield, Utah).

The fortified powdered beverage samples were sealed in aluminum bags (ten bags per sample with each bag containing 22 g of beverage mixture) and then stored for sixteen weeks in controlled environment (i.e., about 85 percent relative humidity and about 90° F.). One week storage under these storage conditions is equivalent to about 1.25 to about 1.5 months under normal storage conditions.

A single bag of each of the eleven types of stored samples was organoleptically evaluated initially (i.e., week zero) and every two weeks thereafter as needed. For evaluation purposes, the 22 g serving portion contained in the sample bag was dissolved in 180 mL tap water in a beaker at room temperature with mixing to provide the respective beverage sample. Sensory attributes were assessed by panelists trained to qualitatively differentiate between slight, moderate, and strong metallic tastes and to recognize the distinctive off-flavor normally associated with any oxidized terpenes from the orange flavoring. The beverage samples were presented to the panelists at room temperature in randomly coded beakers (i.e., blind testing). An average of about 10 (and in no case less than five) panelists was used for each round of sensory tests. Two separate sets of scores were used to summarize the evaluated samples: one for metallic taste and one for overall scores (i.e., combined appearance, flavor, and off-flavor evaluation). Sensory scales of 0 to 8 were used; for metallic taste evaluations, 0 indicates no metallic off-flavor and 8 significant metallic off-flavor; for overall evaluations, 0 indicates very poor and 8 excellent.

The sensory evaluation results are summarized in bar graph form in the FIGURE. The inventive beverage samples (Sample 3) made with sodium iron EDTA (ferric EDTA) were stable and comparable to the negative control sample (i.e., no iron) through the duration of the sixteen week test with minimal off-flavor and no off colors. Further, the inventive beverage samples rated nearly the same in organoleptic attributes as the “no iron” control without requiring any additional preservatives or flavor maskants.

Moreover, the inventive ferric EDTA-fortified beverage samples provided clearly superior results relative to all iron forms tested. Of the iron fortified samples, only the inventive ferric EDTA-fortified beverage sample (Sample 3) gave acceptable results for the entire sixteen week testing period. In contrast, the comparison samples fortified ferrous sulfate, ferrous gluconate, ferrous fumurate, and ferrous tartarate (Samples 2, 6, 9, 10, respectively), had a noticeable metallic off-taste immediately upon formulation which became stronger and was combined with oxidized flavor as the sixteen week trial continued. The comparison samples fortified with encapsulated ferrous sulfate, Ferrochel™, ferrous saccharide, and ferrous citrate (Samples 4, 5, 7, 8, respectively) did not have a noticeable metallic taste at the beginning of the trial; however, all samples developed moderate to strong metallic off-taste combined with oxidized flavor before the end of the sixteen week trial and were considered unacceptable. The negative control (Sample 1 containing no iron) did not, as expected, develop metallic off-taste or oxidation off-flavor during the sixteen week trial. Surprisingly, the inventive ferric EDTA fortified sample also demonstrated better stability than beverage samples formulated with insoluble/low reactive forms such as ferrous fumarate and ferric glycerolphosphate (Samples 7 and 9, respectively). Storage stability tests under regular storage conditions (i.e., non-accelerated) have confirmed the accelerated storage evaluations.

### EXAMPLE 2

This example compares the bioavailability of an inventive beverage sample fortified with ferric EDTA with a control sample fortified with ferrous sulfate. The beverage samples were prepared in the same manner and using the same formulations as Samples 2 and 3 as described in Example 1. The iron bioavailability of each these prepared beverage samples was determined using the ferritin technique as essentially described in U.S. Pat. No. 6,017,713, which is hereby incorporated by reference. Briefly a 0.9 mL of a beverage sample was introduced, along with a standard meal, into a simulated digestion, peptic, and intestinal system (Glahn et al., J. Nutrition, 128, 1555 (1998)). The resulting digestion solution was placed in wells on top of dialysis membrane inserts over a monolayer of human intestinal cancer cells (i.e., Caco-2 cells). Available iron from the sample was absorbed by the Caco-2 cells and stored in the form of ferritin (a storage protein). Ferritin levels were then measured as described in U.S. Pat. No. 6,017,713. The bioavailability of iron from the inventive ferric-EDTA fortified beverage sample was comparable to that of the ferrous sulfate fortified sample.

### EXAMPLE 3

This example compares the stability of inventive ferric EDTA beverage to both negative (i.e., no iron) and positive (i.e., ferrous sulfate) controls ready-to-drink products. Twenty five pound batches of the ready-to-drink (RTD) beverages were made in a pilot plant using the basic formulations described in Table 3 below: Batch 1—negative control; batch 2—inventive product; and batch 3—positive control. Batch 2 and 3 beverages provided about 3.6 mg Fe per 200 ml serving. The formulated RTD beverages were pasteurized at 205° F. for 30 seconds, hot filled in pouches, and sealed.

TABLE 3
Basic RTD Composition before Iron Fortification.

| Ingredient | Amount (%) |
|---|---|
| water | 81.8 |
| corn syrup | 15.9 |
| citric acid | 0.4 |
| fruit juice concentrate | 1.8 |
| vitamin & mineral blend | 0.08 |
| coloring agent | 0.0043 |
| preservative¹ | 0.043 |
| orange flavoring | 0.03 |

¹Sodium benzoate, potassium sorbate, calcium disodium EDTA.

The beverages were subjected to accelerated shelf life tests as essentially described in Example 1 except that 200 ml aliquots of each sample were in lined aluminum pouches and evaluated immediately and once a week over the storage period under the same storage conditions as in Example 1. Sensory evaluations were carried out as described in Example 1. The sensory evaluation results are summarized in Table 4 below using the same 0 to 8 scale as in Example 1.

TABLE 4
Sensory Evaluation Results

| | | Metallic | |
|---|---|---|---|
| Batch | Week | Off-Taste | Overall |
| Batch | 0 | 0 | 6 |
| (negative control) | 1 | 0 | 5.5 |
| | 2 | 0.1 | 5.7 |
| | 3 | 0 | 5.6 |
| Batch 2 | 0 | 0.6 | 5.7 |
| (inventive sample) | 1 | 0.2 | 5.25 |
| | 2 | 0.4 | 5.4 |
| | 3 | 0 | 5.6 |
| Batch 3 | 0 | 2.1 | 4.4 |
| (positive control) | 1 | 2.7 | 3.6 |
| | 2 | 1.5 | 3.7 |
| | 3 | 2.5 | 2.6 |

Under the accelerated storage conditions employed, three weeks is equivalent to about three months in regular storage. At three weeks, the sodium ferric EDTA fortified sample (inventive sample; Batch 2) was stable and was comparable to the no-iron control sample (Batch 1). The ferrous sulfate fortified sample (Batch 3) developed noticeable off-flavors and received unacceptable scores. The stability of inventive sodium ferric EDTA sample is especially notable due to the heat treatment during processing and stability in the ready-to-drink form with no additions made to the formula to enhance stability or mask any off-flavors.

While the invention has been particularly described with specific reference to particular process and product embodiments, it will be appreciated that various alterations, modifications and adaptions may be based on the present disclosure, and are intended to be within the spirit and scope of the present invention as defined by the following claims.

What is claimed is:

1. An iron-fortified beverage comprising ferric EDTA and a potable liquid in amount effective to dissolve at least substantially all of the ferric EDTA.

2. The iron-fortified beverage according to claim 1 further comprising a flavoring agent.

3. The iron-fortified beverage according to claim 2, wherein the ferric EDTA is present in an amount to supply about 1 to about 30 percent of the U.S. DV for iron per fluid ounce of the beverage.

4. The iron-fortified beverage according to claim 2, wherein the ferric EDTA is present in an amount to supply about 1 to about 5 of the U.S. DV for iron per fluid ounce of the beverage.

5. The iron-fortified beverage according to claim 2, wherein the potable liquid is water.

6. The iron-fortified beverage according to claim 2, further comprising protein.

7. The iron-fortified beverage according to claim 2, wherein the beverage is a liquid.

8. The iron-fortified beverage according to claim 2, wherein the beverage is frozen.

9. The iron-fortified beverage according to claim 2, wherein the flavoring agent comprises a fruit juice concentrate, a flavor concentrate, a sweetener, or mixtures thereof.

10. The iron-fortified beverage according to claim 2 further comprising vitamin C.

11. An iron-fortified beverage comprising ferric EDTA in an amount, based on iron content, providing at least about 1 percent of the U.S. DV for iron per fluid ounce of the beverage; a flavoring ingredient comprising flavor concentrate in an amount of about 0.02 to about 1 percent; a sweetener in an amount of about 5 to about 25 percent; and potable water in an amount of about 50 to about 95 percent.

12. The iron-fortified beverage according to claim 11, wherein the ferric EDTA is in amount to provide about 1 to about 5 percent of the U.S. DV for iron per fluid ounce of the beverage.

13. The iron-fortified beverage according to claim 11 further comprising vitamin C.

14. The iron-fortified beverage according to claim 11, further comprising about 0.01 to about 1.0 percent of a preservative.

15. The iron-fortified beverage according to claim 14, wherein the preservative is ascorbic acid, citric acid, lactic acid, malic acid, tartaric acid, or mixtures thereof.

16. A soluble powdered beverage mixture which can be reconstituted in a potable liquid to form an iron-fortified beverage, said mixture comprising ferric EDTA, a flavoring agent, and a stabilizer.

17. The soluble powdered beverage mixture according to claim 16, wherein the stabilizer is a cellulose.

18. The soluble powdered beverage mixture according to claim 16, further comprising citric acid and a vitamin/mineral blend.

19. A soluble powdered beverage mixture according to claim 18, wherein, on a dry weight basis, the ferric EDTA is present at about 0.01 to about 0.1 percent, the citric acid is present at about 40 to about 70 percent, the flavoring agent is present at about 5 to about 25 percent, the stabilizer is present at about 5 to about 15 percent, and the vitamin/mineral blend is present at about 5 to about 15 weight percent.

20. The soluble powdered beverage mixture according to claim 19, wherein the ferric EDTA is present at about 0.02 to about 0.04 percent.

21. The soluble powdered beverage mixture according to claim 19, further comprising a sweetener selected from the group consisting of sucrose, glucose, fructose, hydrolyzed corn starch, maltodextrin, corn syrup solids, lactose, high fructose corn syrup, fructooligosaccharides, artificial sweeteners, and mixtures thereof.

22. The soluble powdered beverage mixture according to claim 19, wherein the vitamin/mineral blend comprising vitamin A, vitamin C, vitamin E, zinc, iodine, and copper.

23. A method for preventing or treating iron-deficiency anemia in a mammal by administering an iron-fortified beverage to the mammal in an effective amount, wherein the iron-fortified beverage comprises ferric EDTA and a potable liquid in amount effective to dissolve at least substantially all of the ferric EDTA.

24. The method according to claim 23, wherein the iron-fortified beverage further comprises a flavoring agent.

25. The method according to claim 23, wherein the mammal is a human.

26. The method according to claim 24, wherein the mammal is a human.
